(19) United States
(12) Patent Application Publication
(10) Pub. No.: US 2025/0058791 A1
(43) Pub. Date: Feb. 20, 2025

(54) METHOD FOR DETERMINING VISUAL AND AUDITORY ATTENTIVENESS OF VEHICLE DRIVER, HOST AND DRIVER MONITORING SYSTEM THEREOF

(71) Applicant: AutoSys (TW) Co., Ltd., Hsinchu County (TW)

(72) Inventors: Peter Chondro, SURABAYA (ID); Jun-Yao Zhong, Hsinchu County (TW); Bo-Yu Chen, Hsinchu County (TW); Tse-Min Chen, Hsinchu County (TW); Jui-Li Chen, Hsinchu County (TW)

(21) Appl. No.: 18/789,370

(22) Filed: Jul. 30, 2024

(30) Foreign Application Priority Data
Aug. 18, 2023 (TW) 112131108

(51) Int. Cl. B60W 50/14; G06V 20/59; G06V 40/16; G06V 40/18

(52) U.S. Cl. CPC B60W 50/14; G06V 20/597; G06V 40/168; G06V 40/18; B60W 2050/143; B60W 2050/146

(57) ABSTRACT

This disclosure provides a method for determining visual and auditory attentiveness of vehicle driver, which comprises: determining a visual attentiveness of a driver according to an image captured by a camera installed inside the vehicle; determining a recognition attentiveness of the driver according to sounds obtained by a microphone installed inside the vehicle; deciding whether to issue a reminder to the driver based on the visual attentiveness and the recognition attentiveness of the driver; when it is necessary to remind the driver after determining the driver's visual and recognition attentiveness, one or a combination of reminder steps will be executed; the reminder steps comprising: issuing a visual reminder by a display device in the vehicle; and issuing a auditory reminder by a speaker in the vehicle.

This non-provisional application claims priority claim under 35 U.S.C. § 119 (a) on Taiwan Patent Application No. 112131108 filed Aug. 18, 2023, the entire contents of which are incorporated herein by reference.

### FIELD OF THE INVENTION

The disclosure relates to a driving safety, in particular to a mechanism of monitoring the attentiveness of driver, and providing a feedback based on the monitoring the attentiveness of driver.

### BACKGROUND

In recent years, there have been significant advancements in technology aimed at assisting or autonomously driving vehicles. Advancements in chip-based systems have significantly improved the recognition, sensing, and control systems of vehicles, enhancing the potential for more reliable and safe fully automated driving vehicles. However, the presence of drivers is necessary before the aforementioned ideal can be achieved.

One crucial factor in ensuring the safety of driving is the attentiveness of the vehicle driver, which includes both recognition and visual attentiveness. Analysis of accident reports from Europe, the United States and Australia between 2019 and 2021 shows that approximately 17% of fatal vehicle accidents are due to the distraction and/or inattentiveness of the vehicle driver. According to the recommendations from the Centers for Disease Control and Prevention (CDC), the driver's distractions can be categorized into three types: visual distractions (gaze deviation incidents), manual distractions (hand deviation incidents), and recognition distractions (attentiveness deviation incidents). Examples of driver attentiveness deficits include interacting with passengers, using a phone, looking inside or outside the vehicle, eating or drinking, singing or dancing, applying makeup, smoking, operating devices, and reaching for objects. The above behaviors of the driver will result in slower reaction times, impeding proper planning and control decisions, such that installing a Driver Monitoring System (DMS) in the vehicle is essential. Based on events detected by sensors of DMS, DMS is used to generate a feedback to the driver, which includes auditory, visual, and/or haptic warning messages to remind the drivers when their attentiveness level falls below a certain threshold.

Typical driver monitoring systems usually only includes optical sensors. However, it is difficult to determine a level of attentiveness of the driver in low-light environments. Therefore, there is an urgent need for a driver monitoring system, device, and method that can improve the above shortcomings, in order to better monitor drivers and provide warnings when their level of attentiveness is low.

### SUMMARY

In one embodiment, the present disclosure provides a method for determining visual and auditory attentiveness of vehicle driver, comprising: determining a visual attentiveness of a driver according to an image of the driver's head captured by a camera installed in a vehicle; determining a recognition attentiveness of the driver according to sounds generated inside the vehicle and captured by a microphone installed in the vehicle; deciding whether to issue a reminder to the driver by determining the driver's visual and recognition attentiveness; and executing one or a combination of reminder steps if it is necessary to remind the driver after determining the driver's visual and recognition attentiveness; wherein the reminder steps comprising: issuing a visual reminder by a display device in the vehicle; and issuing a auditory reminder by a speaker in the vehicle.

Preferably, in order to save computing resources and time, wherein the step of determining the visual attentiveness of the driver further comprising: detecting a face on the image of the driver's head and marking multiple facial features on the image of the driver's head by a neural network; estimating facial vectors of the driver according to positions of the multiple facial features; and determining that the driver's visual attentiveness is inattentive when the facial vectors are outside a predetermined range.

Preferably, in order to save computing resources and time, determining whether both of the driver's eyes are open according to the multiple facial features when the facial vectors are within the predetermined range; and determining that the driver's visual attentiveness is inattentive when both of the driver's eyes are closed.

Preferably, in order to calculate where the driver's pupils are looking, marking positions of two pupils of the driver and estimating two pupil vectors of the driver when it is determined that both of the driver's eyes are open; and determining the driver's visual attentiveness according to the facial vectors and the two pupil vectors.

Preferably, in order to represent the facial vector and/or pupil vector, the facial vectors of the driver are obtained from the relationship between positions of multiple features of a head model and the positions of the multiple facial features on the image of the driver's head, and represented by three Euler angles.

Preferably, in order to represent the facial vector and/or pupil vector, the two pupil vectors of the driver are represented by three Euler angles.

Preferably, in order to reduce high-frequency changes in the facial vector or Euler angles, the step of determining the visual attentiveness of the driver further comprising: filtering the facial vectors through one or any combination of time-series filter, Kalman filter, and low-pass filter.

Preferably, in order to obtain the clear image in low light environment, the image can be captured by the camera in an infrared wavelength.

Preferably, in order to have the best chance of the driver seeing the visual reminder, the display device includes a head up display in front of a driving seat in the vehicle.

Preferably, in order to have the best chance of the driver hearing the auditory reminder, the speaker is located in a headrest of a driving seat in the vehicle.

Preferably, in order to stop the reminders after the driver has regained attentiveness, the method for determining visual and auditory attentiveness of vehicle driver further comprising: executing one or a combination of the following steps when it is not necessary to issue the reminder to the driver, wherein the following steps comprising: stopping the display device in the vehicle from issuing the visual reminder; and stopping the speaker in the vehicle from issuing the auditory reminder.

Preferably, in order to determine the recognition attentiveness, the sounds inside the vehicle is represented by a spectrogram, the step of determining the recognition attentiveness of the driver further comprising: analyzing the spectrogram by a neural network to determine whether the sounds inside the vehicle contain ambient noises and prominent noise that distracts the driver.

In one embodiment, the present disclosure provides a host for performing the method for determining visual and auditory attentiveness of vehicle driver, the host comprises a non-volatile memory and at least one processor that is used to execute at least one instructions in the non-volatile memory.

In one embodiment, the present disclosure provides a driver monitoring system comprising the host, the camera, the microphone, the display device, and the speaker.

The disclosure provides a method, a host, and a driver monitoring system for determining visual and auditory attentiveness of vehicle driver, which can improve the shortcomings of monitoring the driver in low light environment by the use of the images and sounds, so as to better monitor the driver and provide warnings when the driver's attentiveness drops.

### BRIEF DESCRIPTION OF THE DRAWINGS

FIG. 1 is a schematic diagram of a driver monitoring system 100 according to one embodiment of the present disclosure.

FIG. 2 is a block diagram of a driver monitoring system 100 according to one embodiment of the present disclosure.

FIG. 3 is a flowchart of a method 300 of determining visual attentiveness according to one embodiment of the present disclosure.

FIG. 4 is a schematic diagram illustrating a three-dimensional model of the head of the driver 199 and a two-dimensional image 410 projected onto the three-dimensional model according to one embodiment of the present disclosure.

FIG. 5 is a schematic diagram of facial vector according to one embodiment of the present disclosure.

FIG. 6 is a flowchart of a method 600 of determining auditory attentiveness according to one embodiment of the present disclosure.

FIG. 7 is a flowchart of a method 700 of determining visual and auditory attentiveness according to one embodiment of the present disclosure.

### DETAILED DESCRIPTION OF THE PREFERRED EMBODIMENTS

To clarify the objectives, technical solutions, and advantages of this present disclosure, a detailed description of the proposed technical solution will be provided below. Apparently, the described implementations are merely some rather than all of the implementations of the disclosure. All other implementations obtained by a person of ordinary skill in the art based on the implementations of the present specification without creative efforts shall fall within the protection scope of the present disclosure.

The terms “first”, “second”, “third”, and the like in the description, claims, and drawings are used to distinguish between different objects, rather than used to indicate a specified order or sequence. It should be understood that the objects described in this way may be exchanged when appropriate. In the description of the present disclosure, “plurality” means two or more, unless otherwise expressly and specifically qualified. Furthermore, the terms “include” and “comprise” as well as any variants thereof are intended to cover non-exclusive inclusion. Some of the block diagrams shown in the drawings represent functional entities and may not necessarily correspond to physically or logically separate entities. These functional entities may be implemented in software form, or implemented in one or more hardware circuits or integrated circuits, or implemented in different networks and/or processor devices and/or microcontroller devices.

In the descriptions of the present disclosure, unless otherwise specified and limited, it should be noted that terms “mounting”, “mutual connection” and “connection” should be generally understood. For example, the term may be fixed connection, detachable connection or integrated connection may be mechanical connection or electrical connection, may be direct connection, may be indirect connection through an intermediate, or may be internal communication between two elements. A person of ordinary skill in the art may understand specific meanings of the above terms in the present disclosure according to specific situations.

In order to make the objectives, technical solutions, and advantages of the present application more apparent and easy to understand, the present application will be further detailed below in conjunction with the drawings and specific embodiments.

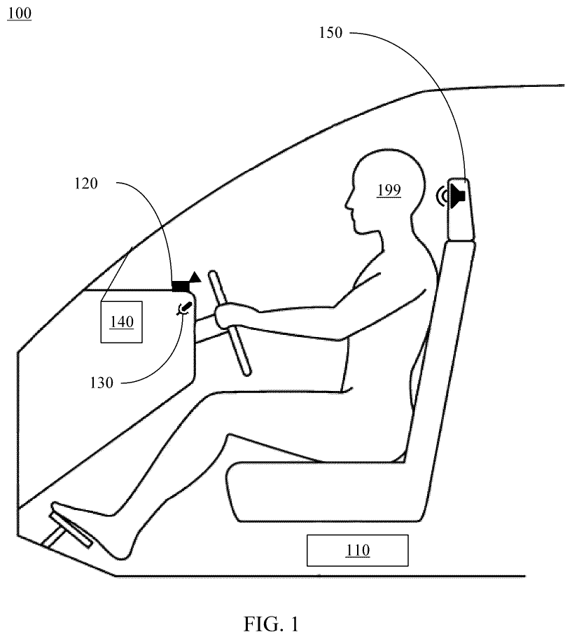

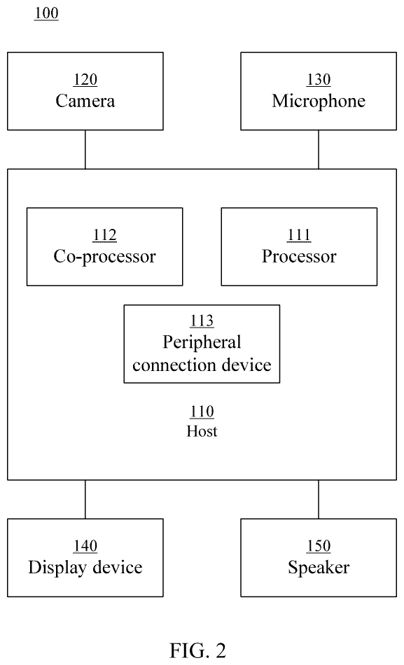

Referring to FIG. 1 and FIG. 2, there are shown a schematic diagram and a block diagram of a driver monitoring system 100 according to one embodiment of the present disclosure. Although the driver monitoring system 100 shown in FIG. 1 is installed inside a car, it is understood by those skilled in the art that the driver monitoring system 100 can be applied to all types of vehicles, such as motorcycles, tricycles, aircraft, watercraft, and spacecraft, as long as there is at least one driver 199 responsible for controlling the vehicle.

The driver monitoring system 100 comprises a host 110, at least one camera 120, at least one microphone 130, at least one display device 140, and at least one speaker 150. As shown in FIG. 1, a shooting range of the camera 120 includes a face of the driver 199. A reception range of the microphone 120 includes being able to capture sounds emitted from a mouth of the driver 199. When the driver 199 is seated in the vehicle, he can see visual contents displayed on the display device 140 and hear auditory contents emitted from the speaker 150. In one embodiment, the display device 140 includes a head up display in front of a driving seat in the vehicle. In one embodiment, the speaker 150 is located in a headrest of the driving seat in the vehicle.

In one embodiment, the display device 140 includes a forward-facing head up display (HUD). In other embodiment, the display device 140 may be a display with functions of virtual reality (Virtual Reality), augmented reality (Augmented Reality) or mixed reality (Mixed Reality). It is understood by those skilled in the art that as long as visual reminders can be provided to the driver 199, even a simple lighting device can serve as the display device 140. Similarly, as long as auditory reminders can be provided to the driver 199, even a simple buzzer can serve as the speaker 150.

In some embodiments, the display device 140 is not entirely controlled by the driver monitoring system 100. For example, the display device 140 may be an independent display device that receives inputs from the driver monitoring system 100 and other systems, and is responsible for integrating and playing the display contents from multiple sources. In some embodiments, similarly, the speaker 150 is not entirely controlled by the driver monitoring system 100. For example, the speaker 150 may be an independent audio device that receives inputs from the driver monitoring system 100 and other systems, and is responsible for integrating and playing the audio contents from multiple sources.

In one embodiment, the camera 120 may include at least one sensor with infrared band. In another embodiment, the camera 120 may include one or more lights with infrared band, such that the sensor with infrared band can capture the face and features of the driver 199 clearly in a low visible light condition through lights with infrared band. In one embodiment, the microphone 130 may include directional sound reception capabilities to focus on the face of the driver 199, especially the mouth on the face of the driver 199, for effective noise cancellation of external disturbances. Taking an example for illustration, the microphone 130 includes multiple sound reception elements that can be arranged in an array, and can focus or scan the direction of sound sources through signal processing. Besides, one or more of the microphones 130 may be used to capture background noises so as to distinguish whether the sound originates from the surroundings or from the driver 199.

The host 100 includes one or multiple processors 111 used to controller the operations of the host 110 and the driver monitoring system 100. The processors 111 can run an operating system to execute drivers or applications within the operating system environment. These software and/or firmware can be stored in non-volatile memory, and contain instructions and data executable by the processors 111 so as to implement the methods and functionalities provided by the disclosure. Those skilled in the art of computer organization, computer architecture, operating systems, system software, and related disciplines should understand that various modifications and derivatives of hardware and software of the host 110 are applicable to this disclosure.

To accelerate the execution of artificial intelligence and/or neural networks for monitoring the driver 199 in real-time, the host 110 may include one or more co-processors 112 designed to provide vectorized arithmetic and logic operation capabilities. The neural networks can encompass one or more types of deep neural networks (DNN) or a collection of deep neural networks. These neural networks may include convolutional neural networks (CNN) or variations thereof. The co-processor 112 can be a graphics processing unit (GPU) or a dedicated processor such as a Neural Network Processor Unit (NPU) for neural networks. Those skilled in the art understand that these co-processors for edge artificial intelligence have been practicalized, so we will not delve into details here.

The host 110 may include one or multiple peripheral connection devices 113 connected to the at least one camera 120, the at least one microphone 130, the at least one display device 140, and the at least one speaker 150. The peripheral connection devices 113 include one or multiple interfaces conforming to one or more industrial standards, such as Bluetooth, USB, IEEE 1394, UART, ISCSI, SATA, PCI-Express, PCT, etc., or include at least one proprietary interface.

The driver monitoring system 100 provided by this disclosure is used to determine a visual attentiveness of the driver 199 by the camera 120 or similar visual sensors, and used to determine a recognition attentiveness of the driver 199 by the microphone 130 or similar auditory sensor. By merging information from multiple modes, such as visual and auditory modalities, the driver monitoring system 100 provided by this disclosure can infer the driver's visual and recognition attentiveness.

Unlike traditional driver monitoring systems that only include optically-based sensors, the driver monitoring system 100 provided by this disclosure can offer more reliable and valuable information related to the driver's attentiveness by analyzing the driver's recognition attentiveness. The driver monitoring system 100 of the disclosure can execute an estimation of the visual attentiveness of the driver 199 based on the driver's facial image, and the estimation process can obtain the driver's facial and eye direction from the driver's facial image by an algorithm. In order to estimate the recognition attentiveness of the driver 199, an algorithm may also be used to estimate auditory events based on the sounds. The auditory events can be classified into multiple categories. For example, the algorithm can determine whether the driver 199 is in a noisy environment or a distracting environment. Finally, when it is decided that the driver's attentiveness level has decreased based on visual and recognition attentiveness, reminders or warnings can be provided to the driver 199 through the display device 140 and/or the speaker 150.

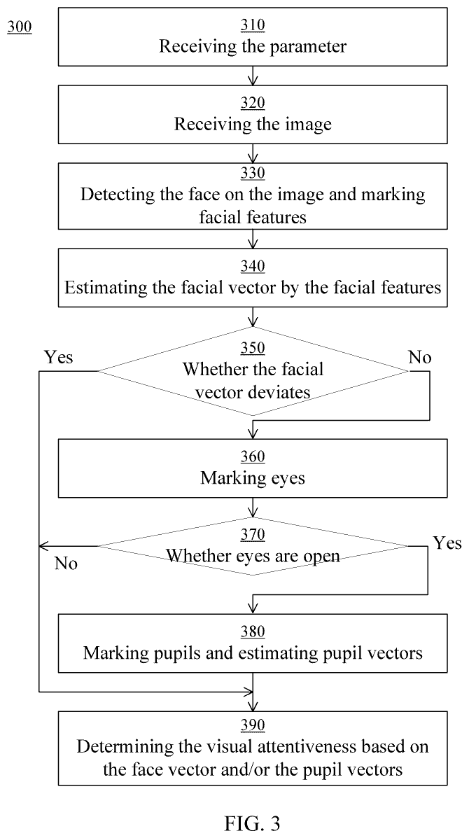

Referring to FIG. 3, there is shown a flowchart of a method 300 of determining visual attentiveness according to one embodiment of the present disclosure. The method 300 of determining visual attentiveness can be implemented by the driver monitoring system 100 shown in FIGS. 1 and 2, particularly executed by the programs running on the host 110. The execution order of these steps is not limited by this disclosure if there is no causal relationship between any two steps. The method 300 of determining visual attentiveness may begin with step 310.

Step 310: receiving or reading the parameters used by the method 300 of determining visual attentiveness, such as one or more transformation matrices, threshold values for deviation angles of facial vector, and other parameters. In one embodiment, the camera device 120 may be calibrated before the method 300 of determining visual attentiveness is executed.

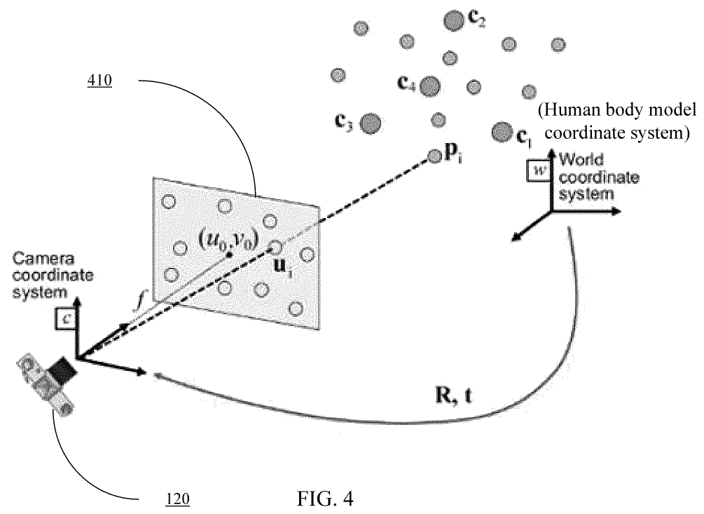

Referring to FIG. 4, there is shown a schematic diagram illustrating a three-dimensional model of the head of the driver 199 and a two-dimensional image 410 projected onto the three-dimensional model according to one embodiment of the present disclosure. The universal human head model contains various features of the face and their corresponding positions, such as eyes, nose, mouth, ears, eyebrows, etc. These facial features have a three-dimensional coordinate in the human body model coordinate system, for example, C1˜C4 shown in FIG. 4.

When the camera 120 captures a two-dimensional image 410 from the face of the driver 199, the facial features will appear in the image 410 and correspond to two-dimensional coordinates uᵢ. After the calibration of the camera 120, the transformation matrix can be generated to convert the two-dimensional coordinates in the image 410 into the three-dimensional coordinates. Based on the three-dimensional coordinate of each of facial features, the direction of the head model's face can be determined. In other words, the facial vector of the head model can be determined.

In another embodiment, the head model of the driver 199 can also be calibrated to obtain a specific transformation matrix for reducing the estimation error of the facial vectors. Alternatively, considering factors such as age, gender, race, etc., different head models can be selected and different transformation matrices can be used to further reduce the estimation error of the facial vectors.

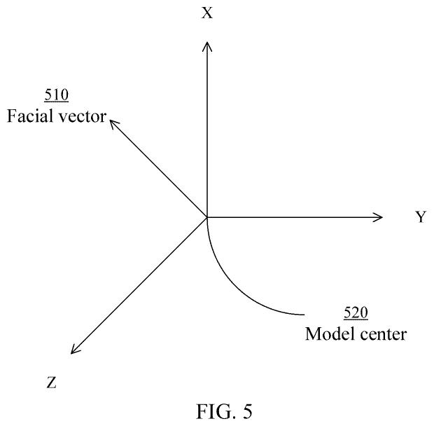

Referring to FIG. 5, there is shown a schematic diagram of facial vector according to one embodiment of the present disclosure. The coordinate system shown in FIG. 5 can be the human body model coordinate system shown in FIG. 4. After obtaining the respective three-dimensional coordinates of one or more facial features, the direction vector of the head model can be obtained by using averaging, weighting, or various algorithms. In the present disclose, the direction vector of the head model can referred to as the facial vector 510.

The facial vector 510 corresponds to a reference point of the head model within the human body model coordinate system, which can be regarded as a model center 520. The facial vector 510 can be represented by three angles, which are pitch angle (pitch), yaw angle (yaw), and roll angle (roll) with respect to three mutually perpendicular axes. These angles are also known as Euler angles. For convenience of explanation, when the facial vector 510 of driver 199 is looking straight ahead, all three Euler angles are 0 degrees. In one embodiment, the facial vector 510 looking straight ahead is parallel to the horizontal plane of the vehicle and aligned with the vehicle's forward direction. Those skilled in the art can understand that Euler angles set to 0 degrees can be adjusted to other angles as required.

Step 320: receiving image from the camera 120.

Step 330: detecting the face on the image and marking facial features. In this step 330, a trained neural network can be used to analyze the image and determine whether it contains a face. When the image does not contain a face, the process of the method 300 of determining visual attentiveness can terminate directly. When the image contains a face, the trained neural network can be used to annotate various facial features on the image. Then, the process proceeds to step 340.

Step 340: estimating the facial vector by the facial features. In this step 340, the techniques mentioned in FIGS. 3 and 4 can be used to find the three-dimensional coordinates of the head model corresponding to the facial features by the parameters received in step 310. Then, the facial vector is estimated by the found three-dimensional coordinates. In one embodiment, the facial vector is represented by three Euler angles. Then, the process proceeds to step 350.

In one embodiment, to reduce high-frequency changes in the facial vector or Euler angles or to add adaptive filters for state estimation, one or any combination of filtering steps involving a time-series filter, a Kalman filter, or a low-pass filter can be added at step 340.

Step 350: determining whether the facial vector deviates beyond a predetermined range. For example, when the driver's facial vector deviates left or right by a certain angle, such as 30 degrees, that is, when the absolute value of the yaw angle exceeds 30 degrees, it can be inferred that the driver is not looking straight ahead, and the process can proceed to step 390. In this way, computational resources for subsequent steps can be conserved. In another example, when the driver's facial vector reaches 15 degrees upward or downward, that is, when the absolute value of the pitch angle is greater than 15 degrees, it can be inferred that the driver is not looking straight ahead, and the process can proceed to step 390. In another example, when the sum of the absolute values of the three Euler angles exceeds a certain threshold, it can be inferred that the driver is not looking straight ahead, and the process can proceed to step 390. In other words, whether the facial vector deviates beyond the predetermined range can be determined based on one or any combination of three Euler angles. If the deviation of the facial vector the range does not exceed this predetermined range, the process continues to step 360.

Step 360: marking eyes. In this step 360, the trained neural network can be used to analyze the image to mark a pair of eyes. Subsequently, the process proceeds to step 370.

Step 370: determining whether a pair of eyes in the image is open. If at least one eye is open, the process will proceed to step 380. When no eyes are open, the process may proceed to step 390.

Step 380: marking pupils and estimating pupil vectors. In this step 380, the techniques mentioned in FIGS. 3 and 4 can be used to find the three-dimensional coordinates of the head model corresponding to the positions of pupils by the parameters received in step 310. Then, one or two pupils are estimated by the found three-dimensional coordinates. In one embodiment, the pupil vectors are represented by three Euler angles. Then, the process proceeds to step 390.

In one embodiment, to reduce high-frequency changes in the pupil vectors or Euler angles or to add adaptive filters for state estimation, one or any combination of filtering steps involving a time-series filter, a Kalman filter, or a low-pass filter can be added at step 380.

Step 390: determining the visual attentiveness based on the facial vector and/or the pupil vectors. In one embodiment, it can be determined that the visual attentiveness of the driver 199 is below the standard if the facial vector deviates too much from the normal range or for too long. In another embodiment, although the facial vector is within the normal range, it can be known that the driver 199 is dozing off, and his visual attentiveness is also below the standard if the pupil vectors cannot be detected for a long time.

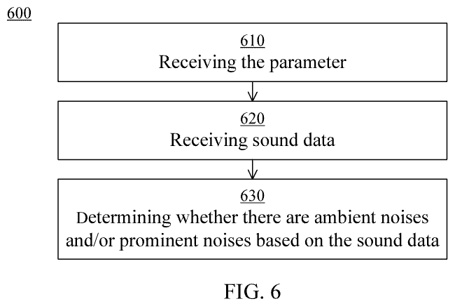

Referring to FIG. 6, there is shown a flowchart of a method 600 of determining auditory attentiveness according to one embodiment of the present disclosure. The method 600 of determining auditory attentiveness can be implemented by the driver monitoring system 100 shown in FIGS. 1 and 2, specifically executed by the programs running on the host 110. The execution order of these steps is not limited by this disclosure if there is no causal relationship between any two steps. The method 600 of determining auditory attentiveness may begin with either step 610 or step 620.

Optional step 610: receiving or reading the parameters used by the method 600 for determining auditory attentiveness, such as the frequency range and duration of the sound data to be determined. Then, the process proceeds to step 620.

Step 620: receiving sound data from the microphone 130. In one embodiment, the sound data can include a spectrogram. This spectrogram can be represented as a two-dimensional array where the first dimension denotes time, the second dimension denotes frequency, and the element values in this two-dimensional array represent the intensity of the sound. Afterwards, the process proceeds to step 630.

Step 630: determining whether there are ambient noises and/or prominent noises based on the sound data. In this step 630, the trained neural network can be used to analyze the sound data so as to determine whether it contains the ambient noises and/or sounds that may distract the driver. In one embodiment, the ambient noises can include engine sounds, air conditioning sounds, brake sounds, etc. The prominent noises can include the sounds of human conversation, music playing, or any sound that may distract the driver. For example, it can determine whether the driver is talking or listening to music by analyzing these prominent noises.

When the ambient noises are not detected, it can be considered that the vehicle is not moving. Therefore, even if there are prominent noises, there is no need to care about the driver's recognition attentiveness. When the ambient noises are detected, it indicates that the vehicle's engine is running, necessitating further consideration of the driver's recognition attentiveness. Thus, when both ambient noises and prominent noises are detected simultaneously, it can indicate that the driver's level of recognition attentiveness is lower.

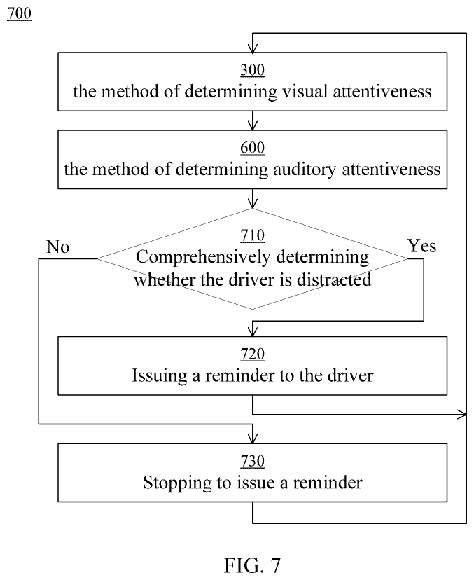

Referring to FIG. 7, there is shown a flowchart of a method 700 of determining visual and auditory attentiveness according to one embodiment of the present disclosure. The method 700 of determining visual and auditory attentiveness can be implemented by the driver monitoring system 100 shown in FIGS. 1 and 2, specifically executed by the programs running on the host 110. The method 700 of determining visual and auditory includes a loop. Each time instructions within the loop are executed, it can start from either the method 300 of determining visual attentiveness or the method 600 of determining auditory attentiveness. The execution order of these methods 300, 600 is not limited by this disclosure. The process proceeds to step 710 after the methods 300 and 600 has executed.

Step 710: comprehensively determining whether the driver 199 is distracted based on the results obtained from the method 300 of determining the visual attentiveness and the method 600 of determining the auditory attentiveness. If the comprehensively results are determined to be distraction, the process proceeds to step 720. If the result of the comprehensively determination is undistracted, the process proceeds to step 730, or repeats the loop to execute the methods 300 and 600 again. In one embodiment, before making the comprehensively determination, this step 710 can also refer to the historical results of methods 300 and 600 executed in one or more previously loops.

In one embodiment, the visual attentiveness obtained from the method 300 and the recognition attentiveness obtained from the method 600 are both determined to be inattentive, the result of comprehensively determination will be inattentive.

In another embodiment, the visual attentiveness obtained from the method 300 and the recognition attentiveness obtained from the method 600 are both determined to be attentive, the result of comprehensively determination will be attentive.

In other embodiment, the above comprehensively results can be determined after looking up a table or performing weighted calculations based on various combinations of current results and/or historical results from methods 300 and 600. Taking an example for illustration, when the pupil vector is not detected in several consecutive loops, regardless of the results obtained from the method 600, the result of comprehensively determination in the latest loop will be inattentive. Taking another example for illustration, when the method 600 detects a very high volume of human voice, regardless of the results obtained from the method 300, the result of comprehensively determination in the latest loop will be inattentive.

Those of ordinary skill in the art can understand that the above comprehensive determination can decide the result based on many combinations of visual attentiveness and recognition attentiveness. The disclosure does not limit the above-mentioned combination types, as long as they can refer to the results and/or historical results of these two types of attentiveness.

Step 720: issuing a reminder to the driver 199. In one embodiment, visual and/or auditory reminders can be provided to the driver 199 through the display device 140 and/or the speaker 150. For example, when the method 300 has determined that the level of visual attentiveness of the driver 199 is low, this step 720 will issue the reminder or warning in auditory type to the driver 199. Conversely, when the method 300 has determined that the level of recognition attentiveness of the driver 199 is low, this step 720 will issue the reminder or warning in visual type to the driver 199.

In one embodiment, when there are multiple display device 140 and the method 300 determines that the driver 199's head is turned towards one of the display devices 140, the step 720 can control that the corresponding display device 140 issues a visual warning to the driver 199. For example, the head of the driver 199 turns to the left, the display device 140 at the left side will be controlled to issue the visual warning.

Step 730: stopping to issue a reminder. When the result of the comprehensively determination in the previous loop considers that the driver 199 is inattentive, it will issue the visual reminder in step 720; sequentially, if the result of the comprehensively determination in the latest loop considers that the driver 199's attentiveness has returned to being attentive, the issuing of the visual or auditory reminder may be stopped.

In one embodiment, the present disclosure provides a method for determining visual and auditory attentiveness of vehicle driver, comprising: determining a visual attentiveness of a driver according to an image of the driver's head captured by a camera installed in a vehicle; determining a recognition attentiveness of the driver according to sounds generated inside the vehicle and captured by a microphone installed in the vehicle; deciding whether to issue a reminder to the driver by determining the driver's visual and recognition attentiveness; and executing one or a combination of reminder steps if it is necessary to remind the driver after determining the driver's visual and recognition attentiveness; wherein the reminder steps comprising: issuing a visual reminder by a display device in the vehicle; and issuing a auditory reminder by a speaker in the vehicle.

Preferably, in order to save computing resources and time, wherein the step of determining the visual attentiveness of the driver further comprising: detecting a face on the image of the driver's head and marking multiple facial features on the image of the driver's head by a neural network; estimating facial vectors of the driver according to positions of the multiple facial features; and determining that the driver's visual attentiveness is inattentive when the facial vectors are outside a predetermined range.

Preferably, in order to save computing resources and time, determining whether both of the driver's eyes are open according to the multiple facial features when the facial vectors are within the predetermined range; and determining that the driver's visual attentiveness is inattentive when both of the driver's eyes are closed.

Preferably, in order to calculate where the driver's pupils are looking, marking positions of two pupils of the driver and estimating two pupil vectors of the driver when it is determined that both of the driver's eyes are open; and determining the driver's visual attentiveness according to the facial vectors and the two pupil vectors.

Preferably, in order to represent the facial vector and/or pupil vector, the facial vectors of the driver are obtained from the relationship between positions of multiple features of a head model and the positions of the multiple facial features on the image of the driver's head, and represented by three Euler angles.

Preferably, in order to represent the facial vector and/or pupil vector, the two pupil vectors of the driver are represented by three Euler angles.

Preferably, in order to reduce high-frequency changes in the facial vector or Euler angles, the step of determining the visual attentiveness of the driver further comprising: filtering the facial vectors through one or any combination of time-series filter, Kalman filter, and low-pass filter.

Preferably, in order to obtain the clear image in low light environment, the image can be captured by the camera in an infrared wavelength.

Preferably, in order to have the best chance of the driver seeing the visual reminder, the display device includes a head up display in front of a driving seat in the vehicle.

Preferably, in order to have the best chance of the driver hearing the auditory reminder, the speaker is located in a headrest of a driving seat in the vehicle.

Preferably, in order to stop the reminders after the driver has regained attentiveness, the method for determining visual and auditory attentiveness of vehicle driver further comprising: executing one or a combination of the following steps when it is not necessary to issue the reminder to the driver, wherein the following steps comprising: stopping the display device in the vehicle from issuing the visual reminder; and stopping the speaker in the vehicle from issuing the auditory reminder.

Preferably, in order to determine the recognition attentiveness, the sounds inside the vehicle is represented by a spectrogram, the step of determining the recognition attentiveness of the driver further comprising: analyzing the spectrogram by a neural network to determine whether the sounds inside the vehicle contain ambient noises and prominent noise that distracts the driver.

In one embodiment, the present disclosure provides a host for performing the method for determining visual and auditory attentiveness of vehicle driver, the host comprises a non-volatile memory and at least one processor that is used to execute at least one instructions in the non-volatile memory.

In one embodiment, the present disclosure provides a driver monitoring system comprising the host, the camera, the microphone, the display device, and the speaker.

The disclosure provides a method, a host, and a driver monitoring system for determining visual and auditory attentiveness of vehicle driver, which can improve the shortcomings of monitoring the driver in low light environment by the use of the images and sounds, so as to better monitor the driver and provide warnings when the driver's attentiveness drops.

1. A method for determining visual and auditory attentiveness of vehicle driver, comprising:
determining a visual attentiveness of a driver according to an image of the driver's head captured by a camera installed in a vehicle;
determining a recognition attentiveness of the driver according to sounds generated inside the vehicle and captured by a microphone installed in the vehicle;
deciding whether to issue a reminder to the driver by determining the driver's visual and recognition attentiveness; and
executing one or a combination of reminder steps if it is necessary to remind the driver after determining the driver's visual and recognition attentiveness;
wherein the reminder steps comprising:
issuing a visual reminder by a display device in the vehicle; an issuing a auditory reminder by a speaker in the vehicle.

2. The method for determining visual and auditory attentiveness of vehicle driver according to claim 1, wherein the step of determining the visual attentiveness of the driver further comprising:
detecting a face on the image of the driver's head and marking multiple facial features on the image of the driver's head by a neural network;
estimating facial vectors of the driver according to positions of the multiple facial features; and
determining that the driver's visual attentiveness is inattentive when the facial vectors are outside a predetermined range.

3. The method for determining visual and auditory attentiveness of vehicle driver according to claim 2, further comprising:
determining whether both of the driver's eyes are open according to the multiple facial features when the facial vectors are within the predetermined range; and
determining that the driver's visual attentiveness is inattentive when both of the driver's eyes are closed.

4. The method for determining visual and auditory attentiveness of vehicle driver according to claim 3, further comprising:
marking positions of two pupils of the driver and estimating two pupil vectors of the driver when it is determined that both of the driver's eyes are open; and
determining the driver's visual attentiveness according to the facial vectors and the two pupil vectors.

5. The method for determining visual and auditory attentiveness of vehicle driver according to claim 2, wherein the facial vectors of the driver are obtained from the relationship between positions of multiple features of a head model and the positions of the multiple facial features on the image of the driver's head, and represented by three Euler angles.

6. The method for determining visual and auditory attentiveness of vehicle driver according to claim 4, wherein the two pupil vectors of the driver are represented by three Euler angles.

7. The method for determining visual and auditory attentiveness of vehicle driver according to claim 2, wherein the step of determining the visual attentiveness of the driver further comprising:
filtering the facial vectors through one or any combination of time-series filter, Kalman filter, and low-pass filter.

8. The method for determining visual and auditory attentiveness of vehicle driver according to claim 1, wherein the image of the driver's head is captured by the camera in an infrared wavelength.

9. The method for determining visual and auditory attentiveness of vehicle driver according to claim 1, wherein the display device includes a head up display in front of a driving seat in the vehicle.

10. The method for determining visual and auditory attentiveness of vehicle driver according to claim 1, wherein the speaker is located in a headrest of a driving seat in the vehicle.

11. The method for determining visual and auditory attentiveness of vehicle driver according to claim 1, further comprising:
executing one or a combination of the following steps when it is not necessary to issue the reminder to the driver, wherein the following steps comprising:
stopping the display device in the vehicle from issuing the visual reminder; and
stopping the speaker in the vehicle from issuing the auditory reminder.

12. The method for determining visual and auditory attentiveness of vehicle driver according to claim 1, wherein the sounds inside the vehicle is represented by a spectrogram, the step of determining the recognition attentiveness of the driver further comprising:
analyzing the spectrogram by a neural network to determine whether the sounds inside the vehicle contain ambient noises and prominent noise that distracts the driver.

13. A host for performing the method for determining visual and auditory attentiveness of vehicle driver according to claim 1, wherein the host comprises a non-volatile memory and at least one processor that is used to execute at least one instructions in the non-volatile memory.

14. A driver monitoring system, comprising the host, the camera, the microphone, the display device, and the speaker of claim 13.
